(19) United States
(12) Patent Application Publication
(10) Pub. No.: US 2009/0323099 A1
(43) Pub. Date: Dec. 31, 2009

(54) PRINTING METHOD AND PRINTER DRIVER PROVIDING USER INTERFACE FOR GENERATING OUTPUT FILES

(75) Inventor: Xiaonong Zhan, Foster City, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 12/163,375

(22) Filed: Jun. 27, 2008

(51) Int. Cl. G06F 3/12; G06F 15/00

(52) U.S. Cl. 358/1.15; 358/1.13; 715/274

(57) ABSTRACT

A printing method is described that allows the user to conveniently either print a document, or generate an output file from it in a desired image file format and save the file for late use, or both at once. The user opens a document using an application, and issues a print request. From the print dialog box, the user chooses to set printing preferences. The print preferences dialog box includes an “output file” tab allowing the user to specify whether an output file is to be generated, specify an output file format, specify a destination for saving the output file, and specify whether hard copies of the document are to be printed on the printer. The method may be implemented as a part of a printer driver program.

### BACKGROUND OF THE INVENTION

1. Field of the Invention

This invention relates to a printer driver and printing method, and in particular, it relates to a printer driver with a user interface and related printing method that allow convenient generation and saving of output files.

2. Description of Related Art

Most application programs provide a user interface (a “Print” user interface) for the user to print a document that is currently open in the application, and to perform related tasks provided by the printer driver, such as setting preferences for the print job. Such a print user interface typically has a “print to file” function that allows the user to generate a print file, such as a PRN (.prn) file, in lieu of actually printing hard copies on the printer. The PRN file is a well formatted file for the destination printer and can be printed directly on that printer at a later time, typically by using a utility tool. A PRN file typically has a large file size. Such a conventional print user interface typically does not allow the user to both print hard copies and generate a PRN file at once.

There are programs that can generate an image file, such as a PDF file, from a file of other formats, such as Microsoft® Word, PowerPoint, etc., using a user interface that resembles a printer driver. Such a program, however, does not allow the user to both print hard copies on the printer and generate an image file at once.

### SUMMARY

Accordingly, the present invention is directed to a printing method and related apparatus that substantially obviate one or more of the problems due to limitations and disadvantages of the related art.

An object of the present invention is to provide a convenient way to print a file on a printer and to generate an output file at once.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a printing method, which includes: (a) a user opening a document using an application program on a computer; (b) the user issuing a print request using the application program; (c) the computer displaying a first user interface display, the first user interface display including first input means for specifying whether the document is to be printed to a printer, second input means for specifying whether an output file is to be generated and specifying an output file format if an output file is to be generated, and third input means for specifying a destination for saving the output file; (d) the user setting first, second and third settings using the first, second and third input means, respectively; (e) the computer submitting the document to the printer for printing if the first setting specifies that the document is to be printed to the printer; and (f) the computer generating an output file having the specified output file format if the second setting specifies that an output file is to be generated, and saving the generated output file in a destination specified by the third setting.

In another aspect, the present invention provides a printing method implemented in a computer, which includes: (a) displaying a first user interface display, the first user interface display including first input means for specifying whether the document is to be printed to a printer, second input means for specifying whether an output file is to be generated and specifying an output file format if an output file is to be generated, and third input means for specifying a destination for saving the output file; (b) receiving first, second and third user inputs via the first, second and third input means, respectively; (c) submitting the document to the printer for printing if the first user input specifies that the document is to be printed to the printer; and (d) generating an output file having the specified output file format if the second user input specifies that an output file is to be generated, and saving the generated output file in a destination specified by the third user input.

In another aspect, the present invention provides a computer program product that causes a computer to perform the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a flow chart illustrating a printing and output file generating process according to an embodiment of the present invention.

FIGS. 2A-2D illustrate user interface displays during in the printing and output file generating process.

FIG. 3 is a flow chart illustrating a process performed by the printer driver according to an embodiment of the present invention.

### DETAILED DESCRIPTION OF PREFERRED EMBODIMENTS

When a user executes a print function from within an application program to print a document that is currently open in the application, sometimes the user may also desire to generate an image file for the document in a popular image file format, such as JPEG (.jpg), TIFF (.tif), PDF (.pdf), XPS (.xps), bitmap (.bmp), etc., and save it for later use such as viewing and/or printing. Sometimes, the user may desire to save an image file in such an image file format without actually printing a hard copy on the printer. A printing method and printer driver program according to embodiments of the present invention provide an output file generation function that allows the user to conveniently either print a document, or generate an output file from it in a desired image file format and save the file for late use, or both at once.

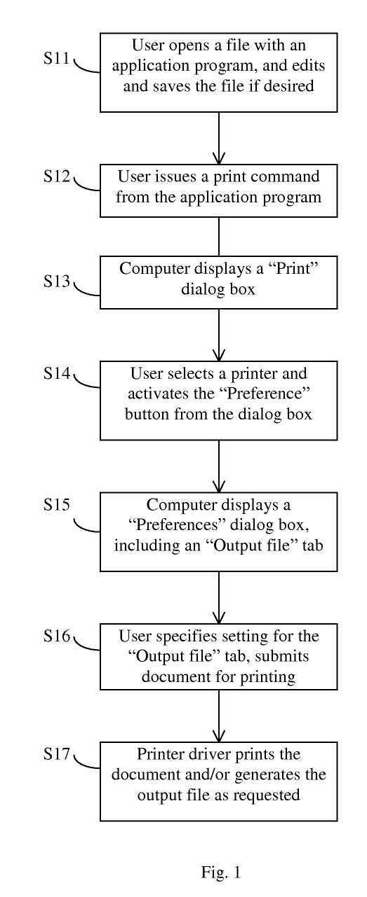

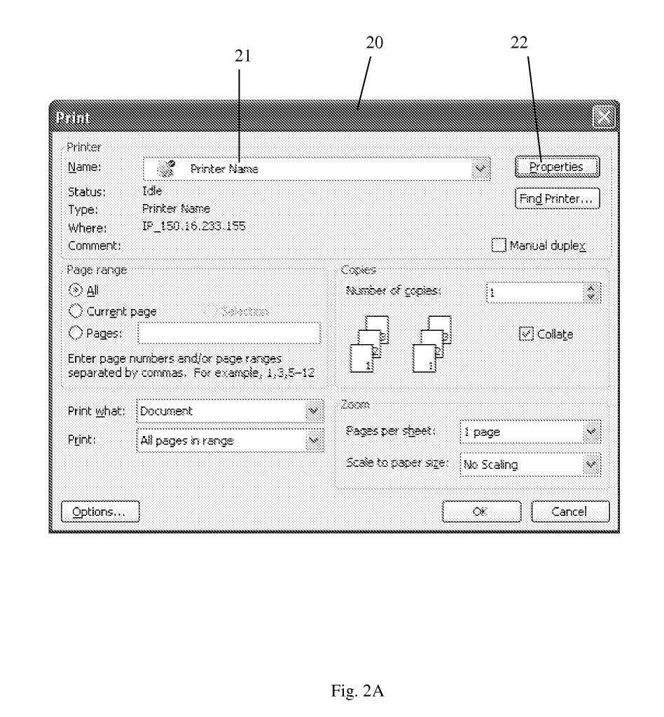

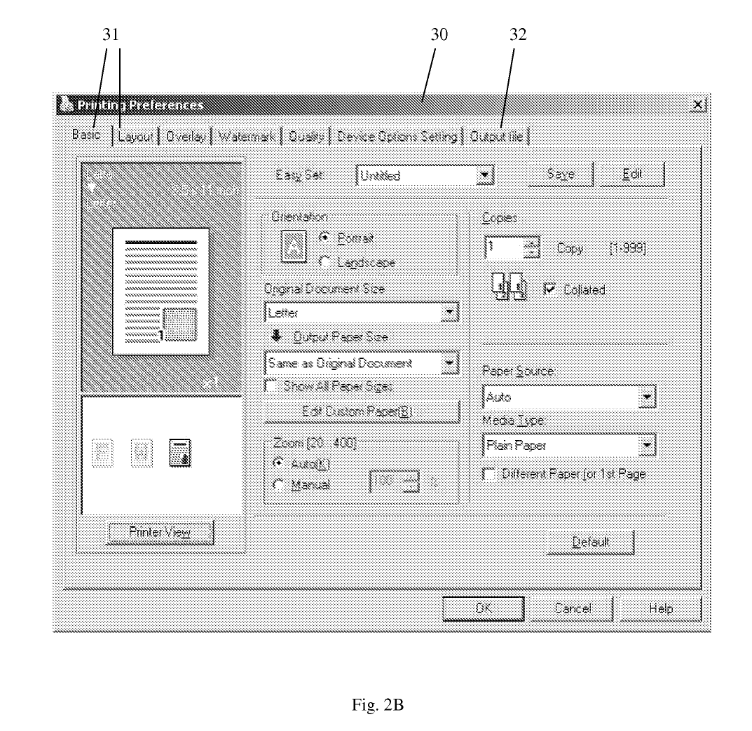

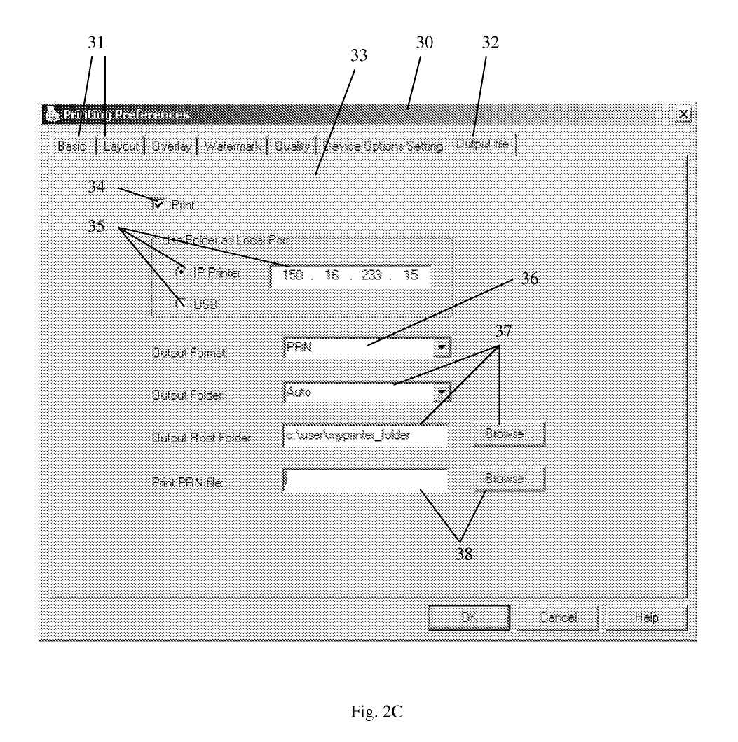

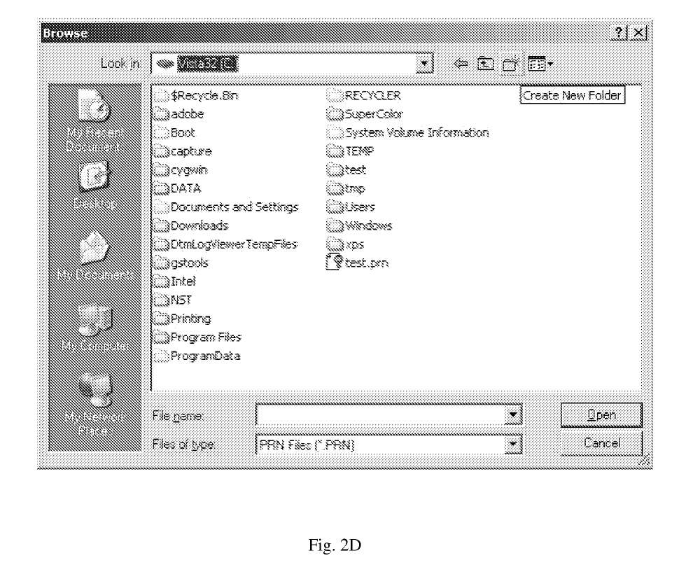

The printing method is described in detail with reference to FIGS. 1 and 2A-2D. FIG. 1 shows the steps of the method. FIGS. 2A-2D illustrate various user interface displays for executing the printing method. First, the user opens a document using an application program (e.g., Microsoft® Word, PowerPoint, etc.) and edits and saves it as desired (step S11). The user then issues a print request from the application program, e.g., by using mouse clicks or keystrokes (step S12). In response, the application program displays a “Print” dialog box 20 (see FIG. 2A) (step S13). The print dialog box 20 has a printer field 21 to allow the user to select a printer and a “Preferences” button 22 to allow the user to set printing preferences of the selected printer. When the user selects a printer and activates the preferences button (step S14), a “Preferences” dialog box 30 is displayed (step S15), an example of which is illustrated in FIG. 2B. The preferences dialog box 30 is provided by the printer driver according to embodiments of the present invention. Note that “Preferences” are sometimes referred to as “Properties” or by some other names depending on the applications. As shown in FIG. 2B, the preferences dialog box 30 has a number of tabs (sheets) 31, many of which are found in a typical conventional printer driver user interface, such as “Basic”, “Layout”, “Overlay”, etc. The user can use these tabs to set various printing preferences he desires.

In the example shown in FIG. 2B, the preferences dialog box 30 includes an “Output file” tab 32 (preferably the top tab) that allows the user to generate output files according to embodiments of the present invention. FIG. 2C illustrates an example of the “Output file” sheet 33 that is displayed when the user selects the output file tab 32 (if it is not automatically displayed as the top tab in the preferences dialog box 30) (see step S15). The output file sheet 33 has a “Print” check box 34, a printer type input means 35, an output format input means 36, an output folder (output file destination) input means 37, and a PRN file input means 38.

The print check box 34 allows the user to specify whether hard copies of the document will be printed to the physical printer. The printer type input means 35 allows the user to specify the type of connection of the printer. It is shown in this example as two radio buttons “IP Printer” and “USB” as well as an edit box for the user to input the IP address if the IP Printer radio button is selected. The printer type input means 35 is optional; it is enabled only when the printer is setup using folder as local port. The output format input means 36 allows the user to specify the file format for the output file. In this example, the output format input means 36 is a box containing a drop-down list of file formats such as NONE (meaning no output file is to be generated), PRN, XPS, JPEG, TIFF, PDF, BMP, etc. The user clicks on the down arrow to display the list, and selects an item from the list. The output folder input means 37 allows the user to specify the location on the computer where the output file is to be saved. In this example, the output folder input means 37 includes a box containing a drop-down list of destinations such as Auto, Document, Secret, Trip, etc. In this example, the destination setting “Auto” means the computer will automatically save the output files to different folders according to the application type or name (e.g., all JPEG files are saved in one particular folder, etc.), and Document, etc. are user defined sub-folders under a root folder. The output folder input means 37 also includes a browse button which will open a browse window to allow the user to browse through the computer and select a folder as the output root folder. Alternatively (not shown in FIG. 2C), the output folder input means 37 may include a browse button that opens a browse window to allow the user to browse through the computer and select any desired folder as the output folder.

The various settings on the output file sheet 33 (FIG. 2C) may be customized in an initial file, which can be a regular text file or an XML file. An example is given below:

output_format=NONE,PRN,XPS,JPEG,TIFF,PDF,BMP
output_folder=Auto,Docuement,Secret,Trip
root_folder=c:\user\myprinter_folder
print=true

In this example, the first line defines the items in the drop-down list of the output format input means 36, the second line defines the items in the drop-down list of the output folder input means 37, the third line specifies the root folder, and the fourth line specifies that the print check box 34 will be checked as a default. If the root folder is not specified in the initial file, the printer driver will use a default root folder which may be set to the local port folder when the printer driver is first set up. Other suitable ways of specifying a default file location may be used.

The PRN file input means 38 allows the user to select a PRN file previously saved on the computer to print it. The PRN file input means includes a browse button which allows the user to browse the folders on the computer and select the PRN file. As pointed out earlier, utility tools are currently available to allow a user to print an existing PRN file to the printer. The PRN file input means 38 provides a convenient way for the user to print a PRN file from the printer driver user interface without using a separate utility tool. FIG. 2D shows an example of a browse window when the browse button of the PRN file input means 38 is clicked. This type of browse windows is familiar to those skilled in the field of computer programming. A similar browse window can be used to select a root folder when the browse button of the output folder input means 37 is clicked.

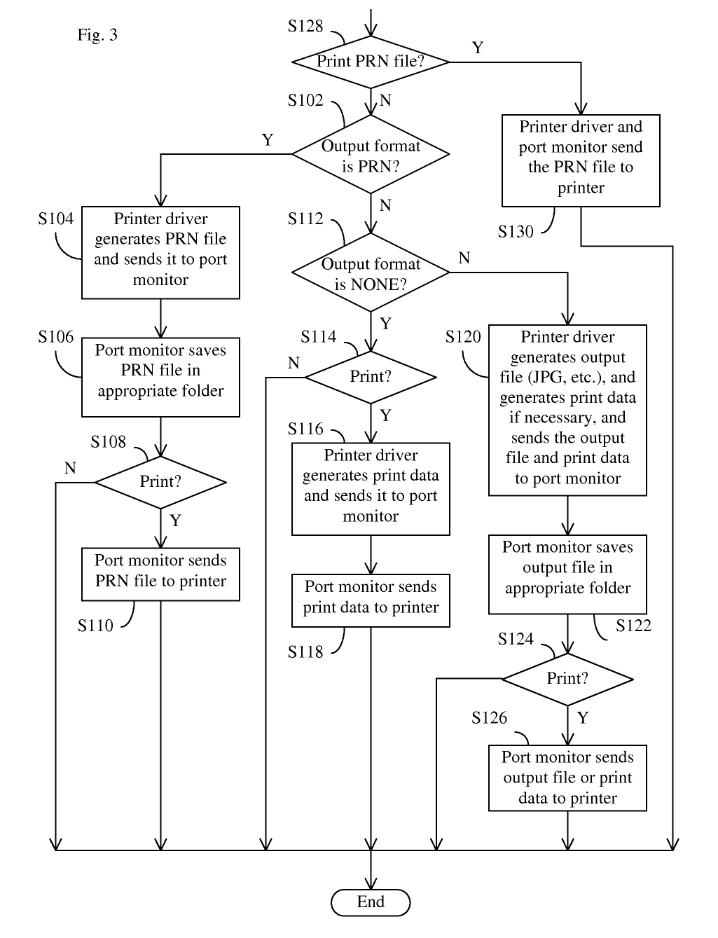

After the user sets the various settings (including accepting the default settings) on the output file sheet 33, including the print check box, the printer type, the output format, the output file destination, and/or the previously saved PRN file selection, the user submits the document for printing (step S16). The printer driver either prints the document, or generates an output file from the document, or both, depending on the settings (step S17). The actions taken by the printer driver to accomplish this step depend on the file format of the output file to be generated, as shown in FIG. 3.

As shown in FIG. 3, if the output format specified by the user is PRN (“Y” in step S102), the printer driver processes the document to generate a PRN file, in a manner known in the art, and sends the PRN file to a port monitor (step S104). The port monitor is provided by the printer driver. The port monitor saves the PRN file in an appropriate folder depending on the output folder setting 37 (step S106). If printing on the printer is requested (i.e. the print check box 34 is checked) (“Y” in step S108), the port monitor sends the PRN file to the printer (step S110), which prints it. If the print check box 34 is not checked (“N” in step S108), the process ends without printing on the printer.

If no output file is requested, i.e., the output format is NONE (“N” in step S102 and “Y” in step S112), and if the print check box 34 is checked (“Y” in step S114), the printer driver processes the document to generate print data (i.e. data in an appropriate form that can be processed and printed by the printer), and sends the print data to the port monitor (step S116). The port monitor sends the print data to the printer (step S118), which prints it. In step S114, if the print check box 34 is not checked (“N”), the process ends without printing on the printer.

If the output format is one of the image file formats other than PRN, e.g., it is one of XPS, JPEG, TIFF, PDF, BMP, etc. (“N” in step S102 and “N” in step S112), then the printer driver processes the document and generates an output file of the specified file format (step S120). Methods for generating files in these file formats are generally known in the art and are not described in detail here. If the output format is XPS (XML Paper Specification), the printer driver may simply call the Windows XPS writer to create the XPS file. In step S120, if printing on the printer is requested and the printer is not capable of directly processing and printing files in the specified file format (e.g., PDF is selected as the output file format but the printer does not support PDF direct printing), then the printer driver additionally generates print data that can be processed by the printer. The printer driver sends the output file in the specified format, along with the print data if it is generated, to the port monitor (step S120). The port monitor saves the output file in an appropriate folder depending on the output folder setting 37 (step S122). If printing on the printer is requested (i.e. the print check box 34 is checked) (“Y” in step S124), the port monitor sends either the output file in the specified format or the print data to the printer, depending on whether the printer is capable of directly processing and printing files in the specified file format (step S126). If the print check box 34 is not checked (“N” in step S124), the process ends without printing on the printer.

If on the output file sheet 33 the user has selected to print a previously saved PRN file using the PRN file browse button 38 (“Y” in step S128), the printer driver and the port monitor send the selected PRN file to the printer for printing (step S130) without performing the steps S102 to S126 described above.

In steps S106 and S122, the port monitor saves the output files in an appropriate folder specified by the user. For example, if the user specified “Auto” as the output folder setting 37, the port monitor will automatically save files to different folders according to the application type or name (e.g., all JPEG files are saved in one particular folder, etc.). If the output folder setting 37 specifies a sub-folder that does not yet exist in the root folder, the port monitor will create such a sub-folder.

Although examples of the user interface displays (FIGS. 2A-2D) are shown and described in detail here, the invention is not limited to the specifics of the user interface displays. The invention may be implemented using any forms of user interface displays, as long as the user interface display includes input means that allows the user to specify various settings. The input means may be buttons, check boxes, radio buttons, text input fields, drop-down menus, pop-up menus, icons, tabs for bringing up different sheets, separate windows, etc., or combinations thereof, or any other suitable structure of allowing the user to input information to the computer. The computer software designs for suitable structures of the input means are apparent and familiar to a person of ordinary skill in this field. Therefore, detailed descriptions for these structures are omitted from here. The term “user interface display” is used to generally mean any suitable screen display that displays information to the user and/or allows the user to input commands and other information, and is not limited to any specific form of display, and may include a series of consecutive displays.

Embodiments of the present invention are preferably implemented as a part of a printer driver program. They may also be implemented as a plug-in or a stand-alone utility program. The hardware structure of a computer is generally known to those skilled in the art and will not be described further.

It will be apparent to those skilled in the art that various modification and variations can be made in the document printing and output file generating method and related apparatus of the present invention without departing from the spirit or scope of the invention. Thus, it is intended that the present invention cover modifications and variations that come within the scope of the appended claims and their equivalents.

What is claimed is:

1. A printing method comprising:
(a) a user opening a document using an application program on a computer;
(b) the user issuing a print request using the application program;
(c) the computer displaying a first user interface display, the first user interface display including first input means for specifying whether the document is to be printed to a printer, and second input means for specifying whether an output file is to be generated and specifying an output file format if an output file is to be generated;
(d) the user setting first and second settings using the first and second input means, respectively;
(e) the computer submitting the document to the printer for printing if the first setting specifies that the document is to be printed to the printer; and
(f) the computer generating an output file having the specified output file format if the second setting specifies that an output file is to be generated, and saving the generated output file.

2. The method of claim 1, wherein the output file format includes one of PRN, JPEG, TIFF, PDF, XPS, and BMP.

3. The method of claim 1, wherein the first interface display further comprises third input means for specifying a destination for saving the output file,
wherein step (d) further includes the user setting a third setting using the third input means, and
wherein in step (f), the computer saves the generated output file in the destination specified by the third setting.

4. The method of claim 3, where the first input means includes a check box,
wherein the second input means includes a drop-down list containing a plurality of output file formats, and
wherein the third input means includes a drop-down list containing a plurality of destinations.

5. The method of claim 1, wherein the first user interface display further comprises fourth input means for specifying an existing print file to be printed, and wherein the method further comprises:
(g) the user specifying an existing print file using the fourth input means; and
(h) the computer submitting the specified print file to the printer for printing.

6. The method of claim 1, wherein the first user interface display further comprises fifth input means for specifying a type of printer.

7. The method of claim 1, further comprising, after step (b) and before step (c):
(i) in response to the print request in step (b), the computer displaying a second user interface display, the second user interface display being generated by the application program, the second user interface display including sixth input means for selecting a printer and seventh input means for issuing a request to set printing preferences; and
(j) the user selecting a printer using the sixth input means and issuing a request to set printing preferences using the seventh input means,
wherein step (c) is performed in response to the request to set printing preferences, and wherein step (c) is performed by a printer driver program.

8. A printing method implemented in a computer, comprising:
(a) displaying a first user interface display, the first user interface display including first input means for specifying whether the document is to be printed to a printer, and a second input means for specifying whether an output file is to be generated and specifying an output file format if an output file is to be generated;
(b) receiving first and second user inputs via the first and second input means, respectively;
(c) submitting the document to the printer for printing if the first user input specifies that the document is to be printed to the printer; and
(d) generating an output file having the specified output file format if the second user input specifies that an output file is to be generated, and saving the generated output file.

9. The method of claim 8, wherein the output file format includes one of PRN, JPEG, TIFF, PDF, XPS, and BMP.

10. The method of claim 8, wherein the first user interface display further comprises a third input means for specifying a destination for saving the output file,
wherein step (b) further includes receiving a third user input via the third input means, and
wherein in step (d), the generated output file is saved in the destination specified by the third user input.

11. The method of claim 10, where the first input means includes a check box, wherein the second input means includes a drop-down list containing a plurality of output file formats, and wherein the third input means includes a drop-down list containing a plurality of destinations.

12. The method of claim 8, wherein the first user interface display further comprises fourth input means for specifying an existing print file to be printed, and wherein the method further comprises:
(e) receiving a fourth user input specifying an existing print file via the fourth input means; and
(f) submitting the specified print file to the printer for printing.

13. The method of claim 8, wherein the first user interface display further comprises fifth input means for specifying a type of printer.

14. The method of claim 8, further comprising, before step (a):
(g) in response to a print request, displaying a second user interface display, the second user interface display including sixth input means for selecting a printer and seventh input means for issuing a request to set printing preferences; and
(h) receiving a sixth user input selecting a printer via the sixth input means and receiving a seventh user input to set printing preferences via the seventh input means,
wherein step (a) is performed in response to the seventh user input.

15. A computer program product comprising a computer usable medium having a computer readable code embodied therein for controlling a computer, the computer readable program code configured to cause the computer to execute a printing process, the process comprising the steps of:
(a) displaying a first user interface display, the first user interface display including first input means for specifying whether the document is to be printed to a printer and a second input means for specifying whether an output file is to be generated and specifying an output file format if an output file is to be generated;
(b) receiving first and second user inputs via the first and second input means, respectively;
(c) submitting the document to the printer for printing if the first user input specifies that the document is to be printed to the printer; and
(d) generating an output file having the specified output file format if the second user input specifies that an output file is to be generated, and saving the generated output file.

16. The computer program product of claim 15, wherein the output file format includes one of PRN, JPEG, TIFF, PDF, XPS, and BMP.

17. The computer program product of claim 15, wherein the first user interface display further comprises third input means for specifying a destination for saving the output file,
wherein step (b) further includes receiving a third user input via the third input means, and
wherein in step (d), the generated output file is saved in the destination specified by the third user input.

18. The computer program product of claim 17, where the first input means includes a check box,
wherein the second input means includes a drop-down list containing a plurality of output file formats, and
wherein the third input means includes a drop-down list containing a plurality of destinations.

19. The computer program product of claim 15, wherein the first user interface display further comprises fourth input means for specifying an existing print file to be printed, and wherein the process further comprises:
(e) receiving a fourth user input specifying an existing print file via the fourth input means; and
(f) submitting the specified print file to the printer for printing.

20. The computer program product of claim 15, wherein the first user interface display further comprises fifth input means for specifying a type of printer.

21. The computer program product of claim 15, wherein the process further comprises, before step (a):
(g) in response to a print request, displaying a second user interface display, the second user interface display including sixth input means for selecting a printer and seventh input means for issuing a request to set printing preferences; and
(h) receiving a sixth user input selecting a printer via the sixth input means and receiving a seventh user input to set printing preferences via the seventh input means,
wherein step (a) is performed in response to the seventh user input.

22. A print setting device for providing a printer driver that has a user interface display of a printer driver, the user interface display including first input means for specifying whether the document is to be printed to a printer, and second input means for specifying whether an output file is to be generated and specifying an output file format if an output file is to be generated.

23. The print setting device of claim 22, wherein the user interface display further comprises third input means for specifying a destination for saving the output file.

24. The print setting device of claim 22, wherein the user interface display further comprises fourth input means for specifying an existing print file to be printed.
